(19) United States
(12) Patent Application Publication
(10) Pub. No.: US 2006/0059257 A1
(43) Pub. Date: Mar. 16, 2006

(54) Message queue tuning

(76) Inventors: Jean-Francois Collard, Sunnyvale, CA (US); Patrick Estep, Rowlett, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/940,173

(22) Filed: Sep. 14, 2004

(51) Int. Cl. G06F 15/173

(52) U.S. Cl. 709/224

(57) ABSTRACT

Message queue tuning is disclosed. A communication routine is provided that is able to record a log entry for a message. A log is obtained by running a software application with the communication routine. The log is evaluated to determine a desired value of a tuning knob for a message queue parameter of the communication routine, and the tuning knob is adjusted to the desired value for running the software application with the communication routine.

### BACKGROUND

Communication libraries are used by software applications to transmit and receive messages between processors or between computers on a data network. In a typical form of message transmission, a sender sends to a receiver a request for sending a message having a specified message size in bytes. The request may or may not include a first data packet of the message, or the entire message. Symmetrically, the receiver sends a receive request over the network, requesting the reception of a message, whose length or sender, or both, may not be known at the time of the receive request. Typically, the receive request also indicates where in memory the incoming message should be placed.

If the receiver has already issued a receive request at the time when the sender's message arrives, then the message is placed where specified in the receive request, and both the sender and the receiver may proceed with the transmission of any remaining portion of the message. However, if the sender's message arrives at the receiver before the communication infrastructure of the receiver has signaled its readiness by sending a receive request, two types of policies, known as protocols, may be implemented: a rendezvous protocol, and an eager protocol.

In a rendezvous protocol, the sender sends an initial message and waits idle for a receive request, which serves as an acknowledgement that the communication infrastructure of the receiver is ready to receive the message. When the sender has received the receiver's receive request, the sender may then send the message, and/or any remaining portion of the message, to be placed in a location in memory that has been reserved by the receiver. Such a method is known as a rendezvous protocol because the sender and the receiver wait for each other. No message queue is generally used in a rendezvous protocol.

In an eager protocol, the sender's message is placed by the receiver into a message queue, which serves as the receiver's waiting area or buffer. There is generally no need for the sender to wait idle for an acknowledgement from the receiver before proceeding to send the entire message. When the receiver is ready, the message queue is checked by the receiver, and the sender's message is found and copied into the location reserved by the receiver. Because the sender and the receiver do not have to wait for each other, an eager protocol may provide better performance. However, an eager protocol is not generally capable of handling incoming messages of arbitrary length, because the amount of memory reserved for the whole waiting queue is limited. If the message size exceeds or is too close to that reserved amount, the eager protocol cannot be honored and the communication library falls back to a rendezvous protocol.

Moreover, for practical reasons, a conventional waiting message queue has a fixed number of blocks, and each block has a fixed and uniform block size. In conventional communication libraries, whenever a message arrives such that the message size is greater than the block size, the communication library does not honor the eager protocol and falls back to a rendezvous protocol to handle that message.

### SUMMARY

In one embodiment, the invention comprises a method for message queue tuning. A communication routine is provided that is able to record a log entry for a stalled message. A log is obtained by running a software application with the communication routine. The log is evaluated to determine a desired value of a tuning knob for a message queue parameter of the communication routine. A tuning knob is not generally a physical knob implemented in hardware, but rather a software-implemented parameter having an adjustable value. The tuning knob is adjusted to the desired value for running the software application with the communication routine.

The foregoing presents a simplified summary of the invention in order to provide a basic understanding of some aspects of the invention. This summary is not an extensive overview of the invention, and is intended to neither identify key or critical elements of the invention nor delineate the scope of the invention. Other features of the invention are further described below.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1A is a diagram illustrating components of an embodiment of the invention.

FIG. 1B is a diagram illustrating further components of an embodiment of the invention.

FIG. 2 is a data flow chart for a communication routine according to an embodiment of the invention.

FIG. 3 is a flow chart illustrating a method for tuning according to an embodiment of the invention.

### DETAILED DESCRIPTION

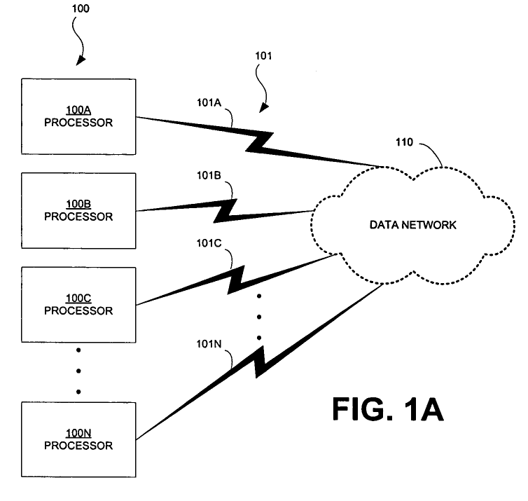

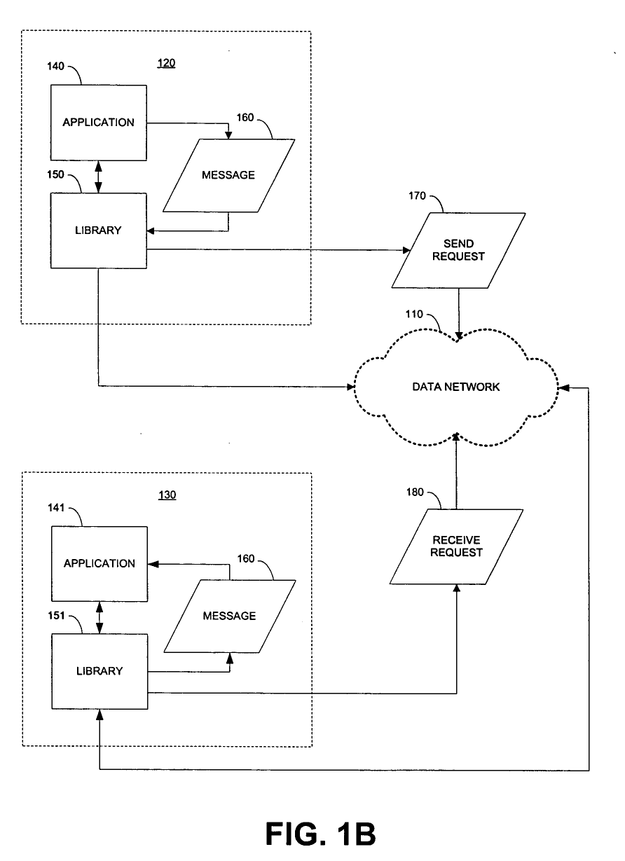

Referring to the drawings, in which like reference numerals indicate like elements, FIG. 1A illustrates components of an embodiment of the invention. A number of processors 100A, 100B, 100C, . . . , 100N (collectively referred to as the processors 100) are communicatively coupled to a data network 110 by respective communication links 101A, 101B, 101C, . . . , 101N (collectively referred to as the communication links 101). The communication links 101 may be wired or wireless, or a combination thereof. Examples of the data network 110 include a network for exchanging data among a plurality of processors 100 on a shared bus, a local or wide-area network, the Internet, or the like.

The processors 100 may be any combination of hardware and/or software able to run a software application and a communication routine for accessing the data network 110, and may be of a single type or of mixed types. The processors 100, communications links 101, and data network 110 may in some embodiments comprise a cluster for parallel processing. Examples of processors 100 include any variety of network node or network-capable computing device, such as central processing units (CPUs), workstations, blades, general-purpose computers having single or multiple CPUs, and the like. The processors 100 may comprise communication adapters, such as network interface cards and the like, for accessing their respective communication links 101 and the data network 110. The processors 100 may also comprise data storage, supporting hardware, and peripherals.

FIG. 1B illustrates further components of an embodiment of the invention. At any given time, any one or more of the processors 100 may be accessing the data network 110 in a sending role or in a receiving role, or may be performing both roles simultaneously. For ease of illustration, an exemplary sender 120 is one of the processors 100, and an exemplary receiver 130 is a different one of the processors 100. The sender 120 and the receiver 130 are communicatively coupled to each other via the data network 110.

The sender 120 runs a first software application 140 with a communication routine such as sender communication library 150. The sender communication library 150 may, for example, be in the form of a dynamic link library (DLL), may be compiled or linked with the first software application 140, or may be otherwise accessible to the first software application 140, such as through an application program interface (API). In some embodiments, the communication routine may be implemented as part of the first software application 140, rather than in a sender communication library 150. In further embodiments, the communication routine may be implemented in hardware or firmware, such as on a communication adapter of the processor 100. The first software application 140 is able to send messages, such as message 160, to a receiver 130, through the communication routine and the data network 110.

Simultaneously, the receiver 130 runs a second software application 141 with a communication routine such as receiver communication library 151. In some embodiments, the communication routine may be implemented as part of the second software application 141, rather than in a receiver communication library 151. In further embodiments, the communication routine may be implemented in hardware or firmware, such as on a communication adapter of the processor 100. The second software application 141 is able to receive messages from a sender 120 through the communication routine and the data network 110.

In some embodiments, the second software application 141 is different from the first software application 140. In other embodiments, the second software application 141 is a copy or a second instance of the first software application 140. The second software application 141 also may be compatible with, functionally identical, or substantially identical to the first software application 140.

In further embodiments, the receiver communication library 151 is a copy or a second instance of the sender communication library 150. The receiver communication library 151 also may be compatible with, functionally identical, or substantially identical to the sender communication library 150. In an illustrative example, the communication libraries 150, 151 may be compatible with the well-known MPI (Message Passing Interface) standard for parallel computing.

When the first software application 140 on the sender 120 attempts to send the message 160 to the receiver 130, the sender communication library 150 generates a send request 170, which is transmitted via the data network 110. The send request 170 comprises data which the receiver communication library 141 is able to recognize as a request for sending a message 160 having a specified message size generally in bytes. The send request 170 may or may not include a first data packet of the message 160, or the entire message 160.

When the receiver communication library 141 on the receiver 130 is ready to receive a message, the receiver communication library 141 generates a receive request 180, which is transmitted via the data network 110. The receive request 180 comprises data which the sender communication library 140 is able to recognize as a request for the reception of an incoming message, whose length or sender identification, or both, may not be known at the time that the receive request 180 is generated. In some embodiments, the receive request 180 also indicates where in a memory of the receiver 130 the incoming message should be placed.

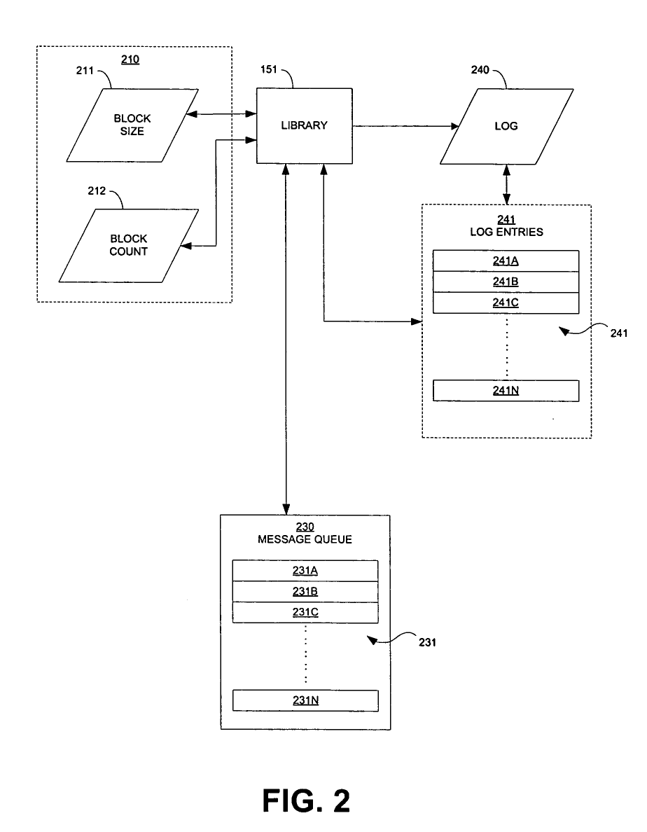

FIG. 2 is a data flow chart for a communication routine, such as receiver communication library 151, according to an embodiment of the invention. Although the illustration depicts the receiver communication library 151 running on the receiver 130, the following discussion applies equally to the sender communication library 150. The communication routines, such as sender and receiver communication libraries 150, 151, may run on respective processors 100 functioning in a sending role, a receiving role, or both.

The receiver communication library 151 has adjustable parameters, which are sometimes known as knobs or tuning knobs 210. Block size 211 and block count 212 are exemplary tuning knobs 210. Block size 211 and block count 212 are message queue parameters relating to a message queue 230, as more fully discussed below.

Tuning knobs 210 are provided to allow parameters of the receiver communication library 151 to be adjusted, such as to improve performance by matching the parameters to actual or expected load characteristics. A tuning knob 210 has a value, such as a numeric value. For example, the value of block size 211 may be a size measured in bytes, and the value of block count 212 may be an integer.

The tuning knob 210 may be adjusted manually, such as by a programmer, network administrator, or the like, or may be adjusted by the second software application 141, or by another computer-implemented software routine, process, object, daemon, or the like. In some embodiments of the invention, the ability to adjust the tuning knob 210 may be an available feature or function of the receiver communication library 151, such as by calling an API. In other embodiments, adjustments to the tuning knob 210 may be accomplished by other methods, which may include patching or recompiling to change a relatively inaccessible value for the tuning knob 210, such as a local or global variable, a constant in a header file, or the like. In further embodiments, the tuning knob 210 may be controllable by a graphical depiction of a knob, slider, dial, or other adjustable control in a user interface.

The receiver communication library 151 manages the message queue 230. The message queue 230 is a waiting area or buffer in memory of the receiver 130, for receiving messages such as message 160. Message queue 230 comprises one or more blocks 231A, 231B, 231C, . . . , 231N, collectively referred to as the blocks 231. The blocks 231 are elements of the message queue 230 for holding an amount of data. The block size 211 is the holding capacity, measured as a size in bytes, of each of the blocks 231. The block count 212 is the number of blocks 231 in the message queue 230.

The receiver communication library 151 is instrumented such that it is able to generate a log 240. The log 240 is generated from an accumulation of data comprising a number of log entries 241A, 241B, 241C, . . . , 241N, collectively referred to as the log entries 241. For example, the log entries 241 may be written to fast data storage such as a table in random access memory (RAM) (not shown); thereafter, at a concluding point for data gathering, the log 240 may be written to a data file on a local or remote disk (not shown), or the like. The log 240 may comprise a summary of the log entries 241, or may comprise a dump of the log entries 241, and may include other information. In some embodiments, the log 240 is formatted for readability by humans. The receiver communication library 151 may provide functionality, such as an API, for specifying a location and/or file name where the log 240 is to be written. In some embodiments, the log 240 may be unique to the receiver 130. In other embodiments, the log 240 may be shared by a plurality of processors 100, by a plurality of communication libraries 150, 151, and/or by a plurality of software applications 140, 141, each of which may be able to cause log entries 241 to be written to the log 240.

A message 160 may be stalled. A stalled message occurs, for example, when a message 160 has a message size which exceeds the block size 211. The block size 211 is also known as the “eager threshold,” because the receiver communication library 151 falls back to a rendezvous protocol when a message 160 has a message size which exceeds the block size 211. In an embodiment of the invention, the tuning knob 210 is used to adjust the eager threshold, and thereby determining when to use an eager protocol instead of a rendezvous protocol in the communication library 151. In an embodiment of the invention, a log entry 241 is generated whenever the receiver communication library 151 receives a message 160 having a message size that exceeds the eager threshold.

A message 160 may also be stalled without causing the receiver communication library 151 to fall back to a rendezvous protocol. A “stalled eager send” occurs if all blocks 231 in the message queue 230 are full upon arrival of the message 160; this may occur, for example, when the receiver 130 or the data network 110 is very slow. In an alternative embodiment of the invention, a log entry 241 is generated whenever the receiver communication library 151 receives a message 160 having a message size that does not exceed the eager threshold, but which nevertheless is stalled because there are no empty blocks 231.

The log 240 may report an identification of the sender 120 and an identification of the receiver 130, which may in some embodiments appear in each of the log entries 241. The log entries 241 record the message size of the stalled message 160. In some embodiments, message sizes of the message 160 are counted in buckets; that is, in groups of size ranges. For example, assuming the block size 211 (corresponding to the eager threshold) is 16 kilobytes (16K), the log 240 may report message sizes in buckets such as a 16K+1 to 32K bucket, a 32K+1 to 64K bucket, a 64K+1 to 128K bucket, a 128K+1 to 256K bucket, and so forth. The size of the buckets need not be uniform. In an illustrative example, an exemplary log 240 may correspond to the following table:

TABLE 1

| Bucket (size range) | Number stalled |
|---|---|
| 16 K + 1 to 32 K | 13 |
| 32 K + 1 to 64 K | 4 |
| 64 K + 1 to 128 K | 25 |
| 128 K + 1 to 256 K | 1 |

Evaluation of the exemplary log 240 might lead one to adjust the tuning knob 210 so as to increase the block size 211 to 128K. The desired value for the block size 211 would have permitted 42 (13+4+25) of the stalled messages 160 to be able to proceed instead of being stalled.

In an alternative embodiment, the log entries 241 record the number of stalled eager sends, for messages 160 having a message size that does not exceed the block size 211. The log 240 may report how many such messages 160 were stalled due to a full message queue 230, and how many times in each case. In an illustrative example, an exemplary log 240 for stalled eager sends may correspond to the following table:

TABLE 2

| Number of messages stalled | Times |
|---|---|
| 1 | 13 |
| 2 | 4 |
| 3 | 25 |
| 4 | 1 |
| 5 | 1 |

Evaluation of the exemplary log 240 might lead one to adjust the tuning knob 210 so as to increase the block count 212 by three. The desired value for the block count 212 would have permitted 42 (13+4+25) of the stalled messages 160 to be able to proceed instead of being stalled.

The evaluation of the exemplary log 240 may be performed by a person such as a programmer, network administrator, or the like, or by a computer-implemented software routine, analysis tool, process, object, daemon, or the like. Using an aspect of the invention, for a given software application 141 running with a receiver communication library 151, answers may be obtained to questions such as the following, for a plurality of message 160: What is the maximum message size encountered? What is the average or mean message size encountered! Was the current value of the block count 212 sufficient to accommodate all messages received, and if not, how many messages 160 were stalled, rejected, or blocked because the queue was full? A desired value may then be determined for a parameter of the message queue 230, such as block size 211 or block count 212, such that the performance of the communication library 151 with a particular second software application 141 will be improved or optimized.

An analysis tool may be provided in some embodiments to automatically evaluate the log 240 and provide a resulting tuning file. The communication library 151 may read such a tuning file for subsequent runs of the software application 141, and may adjust tuning knobs 210 to conform to the improved or optimized settings desired for use with the software application 141.

In some embodiments, an optimal value of the block size 211 or the block count 212 may well vary between different sender-receiver pairs, and may not be symmetrical when roles are reversed between a sender 120 and a receiver 130. That is, the best values of block size 211 and block count 212 for messages 160 from processor 100A to processor 100B may not be the best values for messages 160 from processor 100B to processor 100C, or for messages 160 from processor 100B to processor 100A. Accordingly, in some embodiments, the log 240 comprises a sender identification and a receiver identification, and the desired value is selected for transmitting a message from the sender 120 to the receiver 130. That is, a desired value may be selected for a parameter of the message queue 230, such as block size 211 or block count 212, such that the performance of the communication library 151 with a particular sender-receiver pair of processors 100 will be improved or optimized.

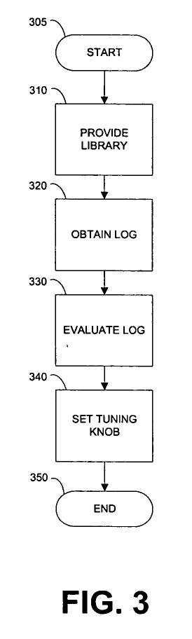

FIG. 3 shows a method for tuning according to an embodiment of the invention. The method begins at start block 305, and proceeds to block 310.

At block 310, a receiver communication library 151 is provided on a processor 100 such as receiver 130, that is able to record a log entry 241 for a stalled message 160. Next, at block 320, a log 240 is obtained by running a second software application 141 with the receiver communication library 151 on the receiver 130. Simultaneously, a first software application 140 may be running with the sender communication library 150 on a sender 120. In some embodiments, the sender communication library 150 may not be able to record a log entry 241 for a stalled message 160, but may in other respects be compatible with or substantially identical to the receiver communication library 151. The recording of the log 240 may be terminated when sufficient log entries 241 have been gathered, such as after a single run or a plurality of runs of the first and second software applications 140, 141, which may, for example, include a test suite or test data suitable for exercising the first and second software applications 140, 141.

At block 330, the log 240 is evaluated to determine a desired value of a tuning knob 210 for a message queue parameter of the receiver communication library 151. For example, the tuning knob 210 may be a block size 211 or a block count 212 for the message queue 230.

At block 340, the tuning knob 210 is set to the desired value for running the software application 141 with the receiver communication library 151. In some embodiments, setting the tuning knob 210 further includes detecting a sender identification for the sender 120 and a receiver identification for the receiver 130, and selecting a desired value corresponding to the sender identification and the receiver identification. The software applications 140, 141 may now be run with the receiver communication library 151 having the tuning knob 210 set to the desired value, thereby obtaining improved performance. The method concludes at end block 350.

Although exemplary implementations of the invention have been described in detail above, those skilled in the art will readily appreciate that many additional modifications are possible in the exemplary embodiments without materially departing from the novel teachings and advantages of the invention. Accordingly, these and all such modifications are intended to be included within the scope of this invention. The invention may be better defined by the following exemplary claims.

What is claimed is:

1. A method for message queue tuning, comprising:
providing a communication routine able to record a log entry,
obtaining a log by running a software application with the communication routine,
evaluating the log to determine a desired value of a tuning knob for a message queue parameter of the communication routine, and
setting the tuning knob to the desired value for running the software application with the communication routine.

2. The method of claim 1 wherein the message queue parameter is a block size.

3. The method of claim 1 wherein the message queue parameter is a block count.

4. The method of claim 1 further comprising terminating recording of the log.

5. The method of claim 1 further comprising running the software application with the communication routine having the tuning knob set to the desired value.

6. The method of claim 1 wherein the log entry is for a stalled message.

7. The method of claim 6 wherein the stalled message has a sender and a receiver, the log comprises a sender identification and a receiver identification, and the desired value is selected for transmitting a message from the sender to the receiver.

8. The method of claim 6 wherein the log entry comprises a message size of the stalled message.

9. The method of claim 6 wherein the log entry comprises a range for a message size of the stalled message.

10. The method of claim 6 wherein the log comprises a count of stalled messages having a message size in a range.

11. The method of claim 6 wherein the log entry comprises a number of stalls for the stalled message.

12. The method of claim 1 wherein the log comprises a number of stalls, and a count of messages that were stalled for the number of stalls.

13. The method of claim 1 wherein setting the tuning knob further comprises
detecting a sender identification and a receiver identification, and
selecting the desired value corresponding to the sender identification and the receiver identification.

14. The method of claim 1 further comprising
providing an analysis tool for evaluating the log, the analysis tool being able to create a tuning file comprising the desired value,
wherein setting the tuning knob further comprises reading the desired value from the tuning file.

15. The method of claim 1 wherein a communication library comprises the communication routine.

16. The method of claim 1 wherein the communication routine is implemented in a communication adapter.

17. A communication routine able to record a log entry for a message, and able to generate a log by running with a software application,
the communication routine comprising a tuning knob for a message queue parameter.

18. The communication routine of claim 17, the tuning knob being adjustable to a selected value for running the software application with the communication routine, the selected value being determined by evaluating the log.

19. The communication routine of claim 17 wherein the message is a stalled message.

20. The communication routine of claim 17 wherein the message has a sender and a receiver, the log comprises a sender identification and a receiver identification, and the selected value is selected for transmitting a message from the sender to the receiver.

21. The communication routine of claim 17 wherein the tuning knob adjusts a threshold to use an eager protocol instead of a rendezvous protocol in the communication routine.

22. The communication routine of claim 17 wherein a communication library comprises the communication routine.

23. The communication routine of claim 17 wherein the communication routine is implemented in a communication adapter.

24. A computer-readable storage medium containing a set of instructions for a communication routine, the set of instructions comprising steps for:
generating a log when called from a software application running with the communication routine,
recording a log entry,
providing a message queue conforming to a message queue parameter,
providing a tuning knob for the message queue parameter, the tuning knob being adjustable to a selected value for running the software application with the communication routine, the selected value being determined by evaluating the log.

25. The computer-readable storage medium of claim 24 wherein the log entry is for a message.

26. The computer-readable storage medium of claim 24 wherein the log entry is for a stalled message.

27. A system for message queue tuning, comprising:
a receiving processor communicatively coupled to a data network for receiving a plurality of messages from a sending processor,
the receiving processor being adapted to run a software application with a communication routine able to generate a log, and
the communication routine having a message queue with an adjustable parameter and a tuning knob for the adjustable parameter.

28. The system of claim 27, the tuning knob being adjustable to a selected value for running the software application with the communication routine, the selected value being determined by evaluating the log.

29. A system for message queue tuning, comprising:
means for generating a log when called from a software application running with a communication routine,
means for recording a log entry,
means for providing a message queue conforming to a message queue parameter, and
means for adjusting the message queue parameter to a selected value for running the software application with the communication routine, the selected value being determined by evaluating the log.

30. The system of claim 29 wherein the log entry is for a stalled message.
